(19) United States
(12) Patent Application Publication
(10) Pub. No.: US 2023/0125369 A1
(43) Pub. Date: Apr. 27, 2023

(54) MACHINE-HUMAN COORDINATION FOR WORKFLOWS

(71) Applicant: AT&T Intellectual Property I, L.P., Atlanta, GA (US)

(72) Inventor: Joseph Soryal, Glendale, NY (US)

(21) Appl. No.: 17/451,909

(22) Filed: Oct. 22, 2021

(51) Int. Cl. G06Q 10/10; G06Q 10/06; G06F 16/23; G06F 1/16; H04L 12/58

(52) U.S. Cl. CPC G06Q 10/103; G06Q 10/063114; G06Q 10/06313; G06Q 10/0633; G06Q 10/06312; G06F 16/2379; G06F 1/163; H04L 51/16; G06Q 2220/00

(57) ABSTRACT

An example method for assisting humans and machines to perform workflow tasks in a coordinated manner includes collecting a plurality of signal inputs associated with a human and a machine who are cooperating to perform a workflow, delegating a first set of tasks of the workflow to the human and a second set of tasks of the workflow to the machine, sending a first signal to the human and a second signal to the machine, wherein the first signal identifies a task of the first set of tasks and the second signal identifies a task of the second set of tasks, and monitoring a progress of the workflow subsequent to sending the first signal and the second signal.

The present disclosure relates generally to workflow automation, and relates more particularly to devices, non-transitory computer-readable media, and methods for assisting humans and machines to perform workflow tasks in a coordinated manner.

### BACKGROUND

Workflow automation refers to the design, execution, and automation of processes based on workflow rules where human tasks, data, or files are routed between people or machines based on pre-defined rules. Many workflows are moving toward full automation in which machines will perform one hundred percent of the tasks. However, many of these workflows are not yet fully automated. Instead, some tasks may be delegated to machines while other tasks are delegated to humans, resulting in a hybrid or partial automation environment.

### SUMMARY

In one example, a method for assisting humans and machines to perform workflow tasks in a coordinated manner includes collecting a plurality of signal inputs associated with a human and a machine who are cooperating to perform a workflow, delegating a first set of tasks of the workflow to the human and a second set of tasks of the workflow to the machine, sending a first signal to the human and a second signal to the machine, wherein the first signal identifies a task of the first set of tasks and the second signal identifies a task of the second set of tasks, and monitoring a progress of the workflow subsequent to sending the first signal and the second signal.

In another example, a non-transitory computer-readable medium may store instructions which, when executed by a processing system in a communications network, cause the processing system to perform operations. The operations may include collecting a plurality of signal inputs associated with a human and a machine who are cooperating to perform a workflow, delegating a first set of tasks of the workflow to the human and a second set of tasks of the workflow to the machine, sending a first signal to the human and a second signal to the machine, wherein the first signal identifies a task of the first set of tasks and the second signal identifies a task of the second set of tasks, and monitoring a progress of the workflow subsequent to sending the first signal and the second signal.

In another example, a device may include a processing system including at least one processor and non-transitory computer-readable medium storing instructions which, when executed by the processing system when deployed in a communications network, cause the processing system to perform operations. The operations may include collecting a plurality of signal inputs associated with a human and a machine who are cooperating to perform a workflow, delegating a first set of tasks of the workflow to the human and a second set of tasks of the workflow to the machine, sending a first signal to the human and a second signal to the machine, wherein the first signal identifies a task of the first set of tasks and the second signal identifies a task of the second set of tasks, and monitoring a progress of the workflow subsequent to sending the first signal and the second signal.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for assisting humans and machines to perform workflow tasks in a coordinated manner may operate;

FIG. 2 illustrates a flowchart of an example method for assisting humans and machines to perform workflow tasks in a coordinated manner, in accordance with the present disclosure; and

FIG. 3 depicts a high-level block diagram of a computing device or processing system specifically programmed to perform the functions described herein.

To facilitate understanding, similar reference numerals have been used, where possible, to designate elements that are common to the figures.

### DETAILED DESCRIPTION

The present disclosure broadly discloses methods, computer-readable media, and systems for assisting humans and machines to perform workflow tasks in a coordinated manner. As discussed above, many workflows, including surgical workflows, manufacturing workflows, and the like, are moving toward full automation in which machines will perform one hundred percent of the workflow tasks. However, many of these workflows are not yet fully automated. Instead, some tasks may be delegated to machines while other tasks are delegated to humans, resulting in a hybrid or partial automation environment. In such hybrid environments, if the actions of the machines and the humans are not well coordinated, efficiency and work quality may suffer. For instance, a human worker on an assembly line may not realize that a robotic system is behind them waiting to perform a task. Alternatively, the human worker may benefit from assistance from the robotic system (e.g., providing a pan to control an item the worker is holding that is dripping), but the robotic system may have no way of anticipating the worker's need if that need is not predefined in the workflow.

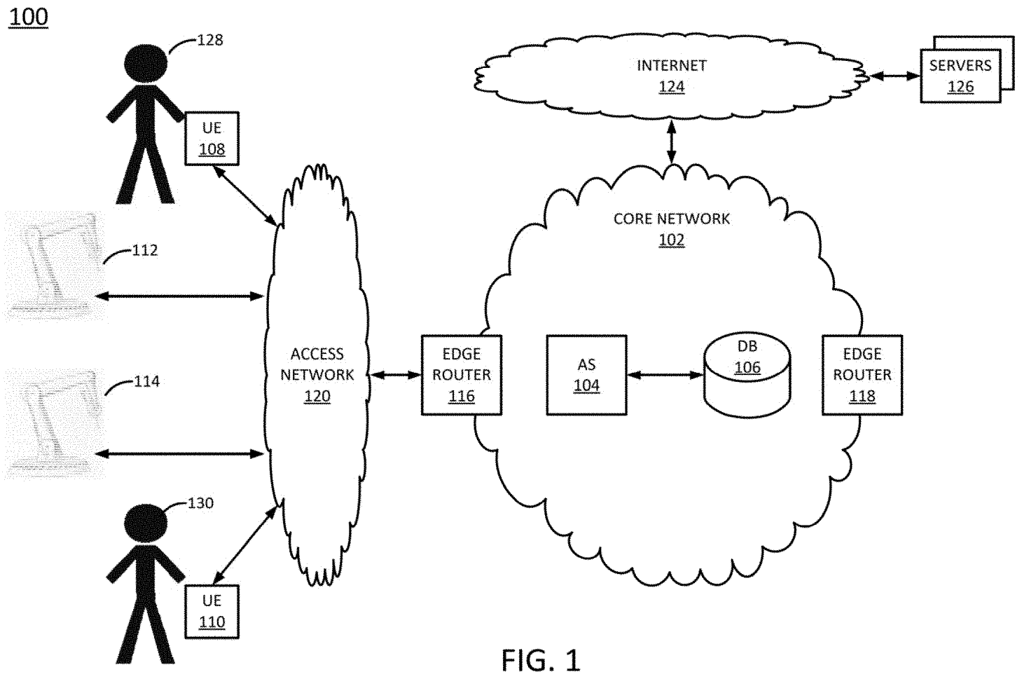

Examples of the present disclosure provide a coordinator system or controller that bridges the gap between human perception and machine-based systems to improve efficiency and accountability in partially automated environments. In one example, the controller may delegate a first set of tasks or steps of a workflow to a human and a second set of tasks or steps of the workflow to a machine (e.g., a robot, a computer, or another device). The controller may then monitor the progress of the workflow as the human and the computer perform their respective tasks and may provide feedback to the human and/or to the machine in order to allow the workflow to progress in a seamless and efficient manner. These and other aspects of the present disclosure are discussed in greater detail below in connection with the examples of FIGS. 1-3.

To further aid in understanding the present disclosure, FIG. 1 illustrates an example system 100 in which examples of the present disclosure for assisting humans and machines to perform workflow tasks in a coordinated manner may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access network 120, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 116-118. For ease of illustration, various additional elements of the core network 102 are omitted from FIG. 1.

In one example, the access network 120 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, or any other types of telecommunication services to subscribers via access network 120. In one example, the core network 102 may be operated by a telecommunication network service provider. The core network 102 and the access network 120 may be operated by different service providers, the same service provider or a combination thereof, or the access network 120 may be operated by an entity having a core business that is not related to telecommunications services, e.g., corporate, governmental, or educational institution LANs, and the like.

In one example, the access network 120 may be in communication with one or more user endpoint devices 108 and 110. In a further example, the access network 120 may also be in communication with one or more machines 112 and 114. The access network 120 may transmit and receive communications between the user endpoint devices 108 and 110 and machines 112 and 114, between the user endpoint devices 108 and 110 and machines 112 and 114, the server(s) 126, the AS 104, other components of the core network 102, devices reachable via the Internet in general, and so forth.

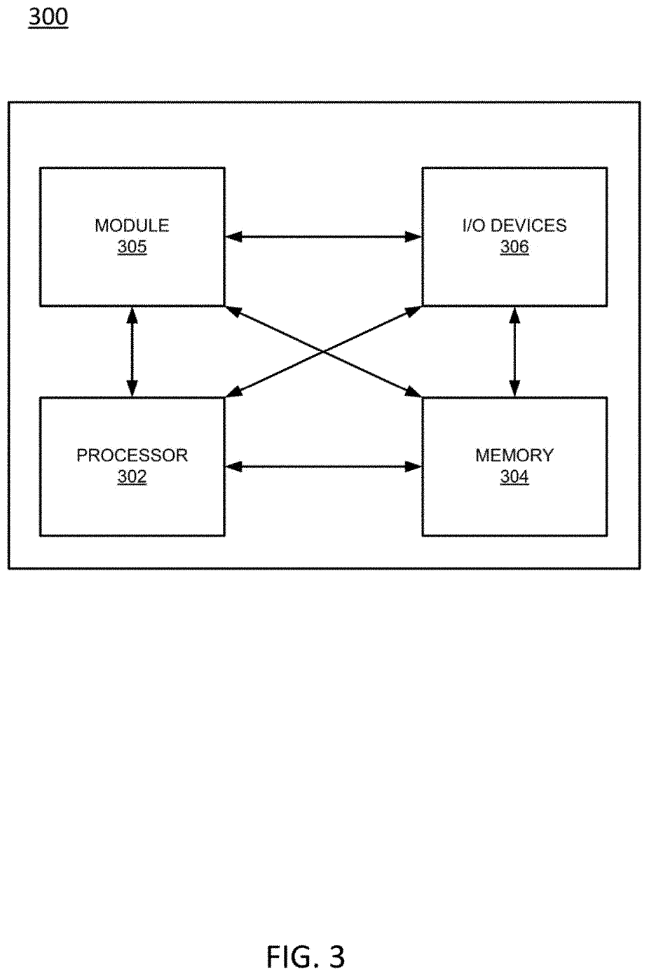

In one example, each of the user endpoint devices 108 and 110 may comprise any single device or combination of devices that may comprise a user endpoint device. For example, the user endpoint devices 108 and 110 may each comprise a mobile device, a cellular smart phone, a gaming console, a set top box, a laptop computer, a tablet computer, a desktop computer, an Internet of Things (IoT) device, a wearable smart device (e.g., a smart watch, a fitness tracker, a head mounted display, or Internet-connected glasses), an application server, a bank or cluster of such devices, and the like. To this end, the user endpoint devices 108 and 110 may comprise one or more physical devices, e.g., one or more computing systems or servers, such as computing system 300 depicted in FIG. 3, and may be configured as described below. In one example, at least some of the user endpoint devices 108 and 110 may be operated by a respective human user. For instance, in the example of FIG. 1, the user endpoint device 108 is operated by a user 128, and the user endpoint device 110 is operated by a user 130. In another example, one or more of the user endpoint devices 108 and 110 may comprise an Internet of Things device or a similar device that is not necessarily directly operated by a human user, but that may monitor the status of a human user. For instance, the user endpoint devices 108 and 110 may include smart security systems that may capture video and/or audio of human users, smart thermostats that may monitor the temperature in spaces where human users are working, smart lighting systems that may monitor the brightness of the lighting in spaces where human users are working, and the like.

In one example, each of the machines 112 and 114 may comprise any single device or combination of devices that may be programmed and/or configured to perform one or more tasks of a workflow in an autonomous manner (e.g., with little to no human assistance). In some examples, these tasks may comprise physical tasks (e.g., as opposed to computing or processing tasks). For instance, the machines 112 and 114 may comprise robots or robotic systems with operating mechanical assemblies, e.g., clutching assembly, cutting assembly, carrying assembly, moving assembly such as wheels or tracks, etc., that are programmed to perform tasks of workflows for performing surgery, for assembling goods on an assembly line, or the like. To this end, the machines 112 and 114 may comprise one or more physical devices, e.g., one or more computing systems or servers, such as computing system 300 depicted in FIG. 3 with operating mechanical assemblies, and may be configured as described below.

In one example, one or more servers 126 may be accessible to user endpoint devices 108 and 110 and to machines 112 and 114 via the Internet 124 in general. The server(s) 126 may operate in a manner similar to the AS 104, which is described in further detail below.

In accordance with the present disclosure, the AS 104 and DB 106 may be configured to provide one or more operations or functions in connection with examples of the present disclosure for assisting humans and machines to perform workflow tasks in a coordinated manner, as described herein. For instance, the AS 104 may be configured to operate as a centralized controller or artificial intelligence (AI) which may receive signal inputs from the user endpoint devices 108 and 110 and from the machines 112 and 114. The AS 104 may analyze these signal inputs in order to identify and monitor the progress of a workflow on which the human users 128 and 130 and the machines 112 and 114 are working in a coordinates manner. The AS 104 may further delegate tasks of the workflow among the human users 128 and 130 and machines 112 and 114 and may communicate information to the human users 128 and 130 (e.g., to the user endpoint devices 108 and 110 which may be operated by the human users 128 and 130) and to the machines 112 and 114, so that the human users 128 and 130 and the machines 112 and 114 have the same understanding as to who is performing which tasks and when.

To this end, the AS 104 may comprise one or more physical devices, e.g., one or more computing systems or servers, such as computing system 300 depicted in FIG. 3, and may be configured as described below. In some examples, the AS 104 may comprise an AI system that may be integrated with other AI systems (potentially located in a workspace of the human users 128 and 130 and machines 112 and 114) into a single AI system.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

The AS 104 may have access to at least one database (DB) 106, where the DB 106 may store information related to a plurality of workflows. In one example, the workflows stored in the DB 106 may be specific to a particular enterprise. For instance, if the enterprise is an automobile manufacturer, the workflows may include workflows for assembling different parts of different models of automobiles with machine or robotic assistance (e.g., installing front and rear suspensions, gas tanks, rear axles and drive shafts, gear boxes, steering box components, wheel drums, braking systems, and the like in the chassis). If the enterprise is a hospital, the workflows may include workflows for different surgeries that may be performed with machine or robotic assistance (e.g., performing a hip replacement, a gallbladder removal, a coronary artery bypass, etc.).

In another example, the DB 106 may store profiles for human users (e.g., human users 128 and 130) and machines (e.g., machines 112 and 114) who are present in a space where a workflow is being performed. For instance, for each human user and machine, a profile may specify the human user or machine's capabilities, limitations, previous workflows in which the human user or machine has participated, and the like. Knowing this information may help the AS 104 to delegate tasks of a workflow among human users and machines in an intelligent manner that considers the optimal use of resources.

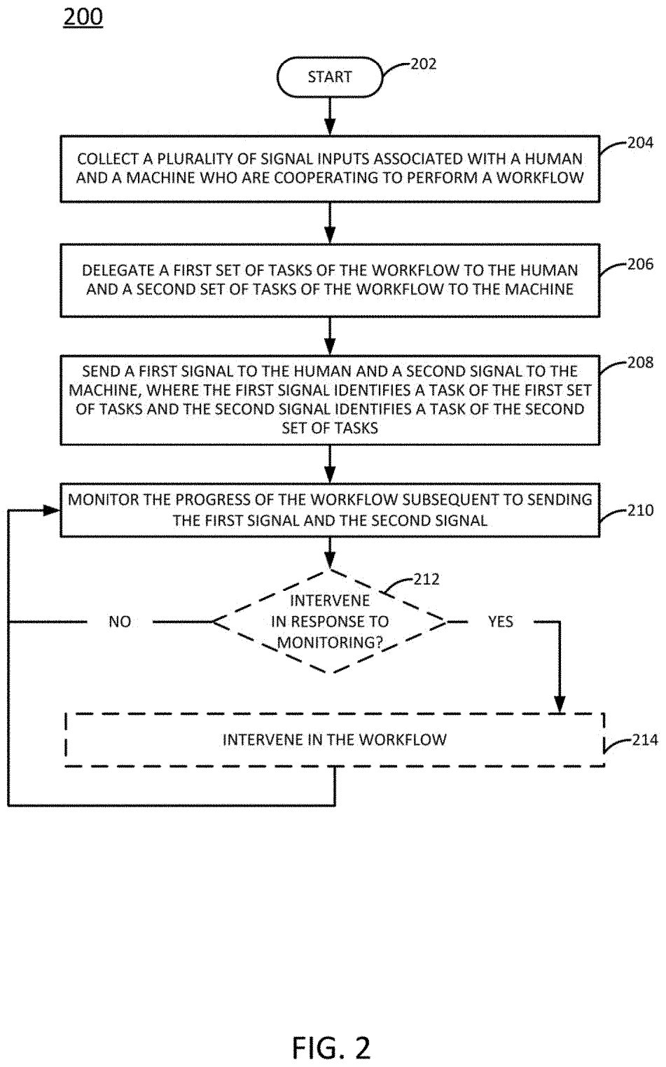

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for assisting humans and machines to perform workflow tasks in a coordinated manner, as described herein. One example method for assisting humans and machines to perform workflow tasks in a coordinated manner is described in greater detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access network 120, and/or Internet 124 may comprise a content distribution network (CDN) having ingest servers, edge servers, and the like. Similarly, although only one access network 120 is shown, in other examples, the access network 120 may comprise a plurality of different access networks that may interface with the core network 102 independently or in a chained manner. For example, user endpoint devices 108 and 110 and machines 112 and 114 may communicate with the core network 102 via different access networks. Thus, these and other modifications are all contemplated within the scope of the present disclosure.

FIG. 2 illustrates a flowchart of an example method 200 for assisting humans and machines to perform workflow tasks in a coordinated manner, in accordance with the present disclosure. In one example, steps, functions and/or operations of the method 200 may be performed by a device as illustrated in FIG. 1, e.g., AS 104 or any one or more components thereof. In one example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processing system 302.

The method 200 begins in step 202 and proceeds to step 204.

In step 204, the processing system may collect a plurality of signal inputs associated with a human and a machine who are cooperating to perform a workflow, e.g., collect signal inputs from a user endpoint device operated by a human and collect signal inputs directly from the machine who are cooperating to perform the workflow. In one example, the signal inputs may comprise any form of data that allows the processing system to identify the workflow, the capabilities of the human, and/or the capabilities of the machine. In one example, the signal inputs may comprise sensor data captured by sensors which are monitoring the human and/or the machine, e.g., a camera capturing images/videos of a work environment, a microphone capturing audio of a work environment, a thermostat capturing a temperature of a work environment, a motion detector detecting motions at a work environment, and the like.

For instance, the signal inputs may comprise video or still images of the human and/or the machine which are captured by a camera or of the location where the workflow is to be performed. The signal inputs may also comprise audio signals (e.g., utterances made by the human, audio alerts generated by the machine, other sounds generated in the location where the workflow is to be performed, etc.) which are captured by a microphone. In further examples, the signal inputs may include readings from one or more biometric or wearable smart devices which are in contact with the human (e.g., smart glasses, a smart watch, a heart rate monitor, a thermometer, an insulin pump, a headset that measures brain electrical activity, etc.). In a further example, the signal inputs may include readings from one or more sensors integrated into the machine (e.g., a monitor that tracks usage of resources such as battery life, processing power, available memory etc. or the strength of the machine's connection to a telecommunications network). In a further example, the signal inputs may include text messages, chat transcripts, or computer-generated reports exchanged between the human and the machine or between the human or machine and another entity (e.g., another human or machine).

In one example, the processing system may identify the workflow that is being performed by the human and by the machine, based on the signal inputs. In one example, identifying the workflow may involve detecting a signal that is provided by the machine or by the human (e.g., via a user endpoint device) that identifies the workflow to be performed. For instance, the human or the machine may select a workflow from among a plurality of stored (e.g., predefined) workflows to which the processing system has access. As an example, if the enterprise is an automobile manufacturer, the workflows may include workflows for assembling different parts of different models of automobiles with machine or robotic assistance (e.g., installing front and rear suspensions, gas tanks, rear axles and drive shafts, gear boxes, steering box components, wheel drums, braking systems, and the like in the chassis). If the enterprise is a hospital, the workflows may include workflows for different surgeries that may be performed with machine or robotic assistance (e.g., performing a hip replacement, a gallbladder removal, a coronary artery bypass, etc.). Each stored workflow may include a set of predefined tasks to be performed in order to complete the workflow and an order in which the individual tasks of the set of predefined tasks are to be performed.

In another example, identifying the workflow may involve analyzing sensor inputs in order to identify the workflow to be performed. For instance, the processing system may perform audio analysis of an audio signal captured by a microphone, where the audio analysis may include using speech recognition to recognize an utterance in which a keyword is spoken. The keyword may be the name of the workflow to be performed or may be related to the workflow to be performed. For instance, a keyword such as “hip” or “prosthetic” could be associated with a workflow for a hip replacement surgery. In another example, the processing system may perform image analysis of one or more images captured by a camera, where the image analysis may include using object recognition techniques to recognize an object that is visible in the images. The object may be related to the workflow to be performed. For instance, if a component of a prosthetic hip is detected in an image, this may indicate that the workflow to be performed comprises a hip replacement surgery. In other examples, other types of processing of other types of sensor data may be utilized to identity the workflow, e.g., scanning of a bar code or a quick response (QR) code by the human or machine in handling one or more objects.

As discussed above, in one example, the workflow may comprise a predefined workflow that is stored in a database. In this case, the tasks that must be performed to complete the workflow, and the order of the tasks, may also be predefined. In other words, a template for the workflow may be accessible to the processing system. The templates may be specific to a given enterprise or individual, or may comprise publicly available templates that are crowdsourced or shared among multiple enterprises or individuals. However, in another example, the workflow that is detected may not be stored, and the processing system may consult one or more external data sources (e.g., a remote database, the Internet, etc.) in order to determine the tasks and the order of the tasks.

In one example, a stored workflow may contain one or more tasks that may be proprietary to a specific enterprise or individual (e.g., a trade secret such as a soft drink recipe). In such cases, if the human and machine do not have authorization to access the proprietary information, then the processing system may modify the workflow by genericizing, omitting, or otherwise altering the proprietary tasks. Furthermore, location-related context may necessitate other modifications to the workflow by the processing system. For instance, depending on the location (e.g., country or state) in which the workflow is to be performed, local laws may prohibit certain tasks (e.g., the use of paint containing certain ingredients, such as lead, in threshold quantities). Similarly, depending on the location, it may be appropriate to convert units of measure from one system to another (e.g., converting units of measure that are specified using the metric system to imperial units of measure for a workflow to be performed in the United States).

In another example, the processing system may determine the capabilities of the human and the capabilities of the machine, based on the signal inputs. In one example, the capabilities of the human and/or the machine may be determined by first identifying the human and/or the machine, and then retrieving a profile for the human and/or the machine that corresponds to the identity. For instance, the human may log into a system that provides workflow assistance utilizing a user name and/or password. Thus, the human may be identified from the user name and/or password. The machine may be associated with a unique identifier (e.g., IP address, media access control address, subscriber identification module card, or the like) that is detectable by the processing system through communication with the machine.

In another example, the processing system may utilize sensor data to infer the capabilities of the human and the capabilities of the machine. For instance, the processing system may perform image recognition on an image of the machine to identify a make and model of the machine. The processing system may then look up the capabilities of the machine based on the make and model information, e.g., by consulting an external data source such as the Internet. Alternatively, the processing system may detect, based on analysis of an image of the machine, that the battery life of the machine is low and that the machine may only be available to assist for a limited period of time. The processing system could also perform image processing on an image of the human to estimate the human's height; based on the human's estimated height, the processing system may infer that the human may not be tall enough to perform certain tasks. Alternatively, the processing system may detect that the human's left arm is in a cast and is not usable for tasks that require the use of both hands. In other examples, the processing system may infer the capabilities of the human and/or the capabilities of the machine from other types of sensor data.

In step 206, the processing system may delegate a first set of tasks of the workflow to the human and a second set of tasks of the workflow to the machine. In one example, the tasks may be delegated based at least in part on the workflow that is identified and the capabilities that are determined in accordance with step 204. For instance, as discussed above, identifying the workflow may include identifying a template that specifies a set of tasks to be performed and an order in which to perform the sets of tasks. Based on the capabilities that were determined for the human and for the machine, the processing system may then determine which of the tasks the human is capable of performing and which of the tasks the machine is capable of performing. In some cases, both the human and the machine may be capable of performing a given task, but it may be more efficient or more cost effective to delegate the task to the machine rather than the human, or vice versa. In other examples, a task may best be performed by the human and the machine working together. In one example, if a template for the workflow is available, metadata associated with the template may indicate, for at least some of the tasks, a recommended party to which to delegate the tasks (e.g., human or machine). For instance, based on observations of previous performances of the workflow, an optimal delegation of tasks may already be known.

As an example, a workflow for painting a car may indicate that the car needs to be painted uniformly, that the paint should not be dropped on the floor, and that the paint should not be brought within x feet of a heat source (e.g., a torch) to avoid combustion. The tasks of painting the car and holding the paint so that the paint does not drop may be delegated to one or more machines, while the task of ensuring that the paint stays away from any heat sources may be delegated to the human. In another example, a workflow for performing a surgery may indicate that the patient's blood loss should be monitored during the surgery, that specific incisions are to be made, and that the surgeon will require specific instruments to perform the surgery. The task of monitoring blood loss may be delegated to a first machine. The task of acquiring the necessary instruments may be delegated to a second machine. Some of the incisions may be delegated to a human surgeon, while other incisions may be delegated to a machine which may be better equipped to perform the incisions with high precision when needed.

In one example, all delegations of tasks for a workflow may be stored in a single block chain. For instance, the block chain may store, for each task, a description of the task, a signal input on which the task may be based (e.g., perform the task in response to detecting an occurrence of a specific trigger), to whom the task has been delegated (e.g., specific human or machine), what time the task is expected to be performed, a location at which the task is expected to be performed, and/or other information.

In step 208, the processing system may send a first signal to the human and a second signal to the machine, where the first signal identifies a task of the first set of tasks and the second signal identifies a task of the second set of tasks. Thus, the first signal and the second signal inform the human and the machine of the tasks that have been respectively delegated to the human and the machine. In one example, the first signal may further identify to the human one or more tasks that have been delegated to the machine, while the second signal may further identify to the machine one or more tasks that have been delegated to the human. Thus, the processing system may provide the human and the machine with some awareness as to what the other is or will be doing with respect to the workflow. For instance, where the workflow defines tasks for performing a surgery, the first signal may instruct the human to make an incision in a specific location on a patient, and may also inform the human that the machine will retrieve the instruments the human will need to make the incision.

In one example, the processing system may send the second signal directly to the machine (e.g., via wired or wireless communications). For instance, the second signal may comprise a machine readable signal or code that can be translated into an action by the machine. The processing system may send the first signal to a user endpoint device of the human (e.g., a mobile phone, a pair of smart glasses, a smart watch, a set of earbuds, a display, a speaker, or the like). The processing system may also communicate with the user endpoint device via wired or wireless communications. For instance, the second signal may be provided as visual (e.g., text, image, hologram, extended reality, or video based) instructions, audible (e.g., spoken) instructions, or another type of signal that is readable (i.e., understandable) by the human.

In step 210, the processing system may monitor the progress of the workflow subsequent to sending the first signal and the second signal. In one example, monitoring the progress of the workflow may involve continuing to collect signal inputs from the human and from the machine, as in step 204. For instance, signal inputs may be collected continuously throughout performance of the method 200 in order to allow the processing system to adjust any previous delegations of tasks, to delegate new tasks, or to make other modifications to the workflow as needed.

For instance, in optional step 212 (illustrated in phantom), the processing system may determine whether to intervene in response to the monitoring. As an example, the processing system may detect, through the monitoring, that an unexpected event (or an event that may otherwise defeat the purpose of the workflow) has occurred (e.g., a can of paint has been spilled, anesthesia is taking longer than expected to take effect on a patient, there is a power loss event, etc.). In a further example, the unexpected event may be detected by the machine (or by anther machine in the work space) and reported to the processing system. Based on the occurrence of the unexpected event, the processing system may modify the workflow (e.g., generate a new instruction to send to the machine to retrieve items with which the human can clean the spilled paint, generate a new instruction to the human to wait before commencing a surgery, etc.). In one example, the processing system may employ machine learning techniques in order to determine how to respond to any events that may deviate from the predefined workflow.

If the processing system determines in step 212 that the processing system should intervene in response to the monitoring (e.g., in response to the detection of an unexpected event), then the method 200 may proceed to optional step 214 (illustrated in phantom), and the processing system may intervene in the workflow. As discussed above, intervention by the processing system may involve adjusting the delegation of tasks. In another example, intervention by the processing system may involve generating an alert rather than modifying the workflow. For instance, if the processing system detects that either the human or the machine is performing an action that is not a delegated task, or that the human or the machine is performing a delegated task improperly, the processing system may attempt to intervene by generating an alert to get the attention of the human or the machine.

As an example, a purpose of a surgical workflow is for the patient to survive the surgery. Thus, if the machine disables (e.g., unplugs, turns off, or improperly adjusts the settings of) a ventilator too soon, this may jeopardize the patient's life and therefore defeat a purpose of the workflow. In this case, the processing system may generate an alert, such as an audible alarm or spoken message, to notify the human of the disabled ventilator. Similarly, a purpose of a workflow for painting the exterior of a car is to not inadvertently paint other portions of the car. Thus, if the human is detected to be painting the wrong portion of a car, the processing system may generate an alert, such as an audible alarm, a visible flashing notification on a set of smart glasses, a haptic output on a smart watch, electromagnetic waves generated by a nearby wave emitter, or the like to cause the human to stop painting the wrong portion of the car.

The method may return to step 210 and may continue to monitor the workflow, intervening when and as deemed necessary, until the workflow is completed. Once the workflow is completed, the method 200 may end.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for assisting humans and machines to perform workflow tasks in a coordinated manner, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for assisting humans and machines to perform workflow tasks in a coordinated manner (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for assisting humans and machines to perform workflow tasks in a coordinated manner (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
collecting, by a processing system including at least one processor, a plurality of signal inputs associated with a human and a machine who are cooperating to perform a workflow;
delegating, by the processing system, a first set of tasks of the workflow to the human and a second set of tasks of the workflow to the machine;
sending, by the processing system, a first signal to the human and a second signal to the machine, wherein the first signal identifies a task of the first set of tasks and the second signal identifies a task of the second set of tasks; and
monitoring, by the processing system, a progress of the workflow subsequent to sending the first signal and the second signal.

2. The method of claim 1, wherein the plurality of signal inputs comprises signals collected from at least one of: a sensor located in a location where the workflow is to be performed, the machine, or a user endpoint device operated by the human.

3. The method of claim 1, wherein the plurality of signal inputs comprises at least one of: an image collected from a location where the workflow is to be performed, audio collected from the location where the workflow is to be performed, an image of the machine or of the human, an audio signal emitted by the machine or by the human, a reading from a biometric or wearable smart device which is in contact with the human, a reading from a resource usage sensor integrated into the machine, text messages exchanged between the human and the machine or between the human or machine and another entity, a chat transcript of a conversation between the human and the machine or between the human or machine and the another entity, or a computer-generated report exchanged between the human and the machine or between the human or machine and the another entity.

4. The method of claim 1, wherein the plurality of signal inputs identifies at least one of: the workflow, a capability of the human, or a capability of the machine.

5. The method of claim 4, wherein the workflow is identified from among a plurality of stored workflows based on the plurality of signal inputs.

6. The method of claim 5, wherein the workflow is associated with a template that defines a predefined set of tasks including the first set of tasks and the second set of tasks, and an order in which individual tasks of the predefined set of tasks are to be performed.

7. The method of claim 5, wherein the delegating comprises modifying the predefined set of tasks to genericize, omit, or alter an individual task of the predefined set of tasks which is identified as being proprietary to a specific enterprise.

8. The method of claim 4, wherein the workflow is generated by using data from an external data source, wherein the data is identified based on the plurality of signal inputs.

9. The method of claim 2, wherein the delegating is based at least in part on the at least one of: the workflow, the capability of the human, or the capability of the machine.

10. The method of claim 1, wherein the delegating is performed based on a recommendation in a template associated with the workflow, wherein the recommendation indicates whether the human or the machine is preferred for performing a given task of the first set of tasks or the second set of tasks.

11. The method of claim 1, wherein delegations of the first set of tasks and the second set of tasks are stored in a single block chain.

12. The method of claim 11, wherein the block chain stores, for each task of the first set of tasks and the second set of tasks, at least one of: a description of the each task, a signal input of the plurality of signal inputs on which the each task is based, to whom the each task has been delegated, a time at which the each task is expected to be performed, or a location at which the each task is expected to be performed.

13. The method of claim 1, wherein the first signal further identifies to the human one or more of the second set of tasks, and wherein the second signal further identifies to the machine one or more of the first set of tasks.

14. The method of claim 1, wherein the second signal is sent directly to the machine, and wherein the second signal comprises a machine readable signal or code that is capable of being translated into an action by the machine.

15. The method of claim 1, wherein the first signal is sent to a user endpoint device operated by the human, and wherein the first signal comprises a signal that is observable by the human.

16. The method of claim 15, wherein the first signal comprises at least one of: visual instructions or audible instructions.

17. The method of claim 1, further comprising:
determining, by the processing system in response to the monitoring, an intervention in the workflow.

18. The method of claim 17, wherein the intervention in the workflow comprises an adjustment to a delegation of at least one of: the first set of tasks or the second set of tasks.

19. A non-transitory computer-readable medium storing instructions which, when executed by a processing system including at least one processor, cause the processing system to perform operations, the operations comprising:
collecting a plurality of signal inputs associated with a human and a machine who are cooperating to perform a workflow;
delegating a first set of tasks of the workflow to the human and a second set of tasks of the workflow to the machine;
sending a first signal to the human and a second signal to the machine, wherein the first signal identifies a task of the first set of tasks and the second signal identifies a task of the second set of tasks; and
monitoring a progress of the workflow subsequent to sending the first signal and the second signal.

20. A device comprising:
a processing system including at least one processor; and
a non-transitory computer-readable medium storing instructions which, when executed by the processing system, cause the processing system to perform operations, the operations comprising:
collecting a plurality of signal inputs associated with a human and a machine who are cooperating to perform a workflow;
delegating a first set of tasks of the workflow to the human and a second set of tasks of the workflow to the machine;
sending a first signal to the human and a second signal to the machine, wherein the first signal identifies a task of the first set of tasks and the second signal identifies a task of the second set of tasks; and
monitoring a progress of the workflow subsequent to sending the first signal and the second signal.
